(19) United States
(12) Patent Application Publication
(10) Pub. No.: US 2025/0346472 A1
(43) Pub. Date: Nov. 13, 2025

(54) ATTACHMENT FOR HYDRAULIC JACK THAT AIDS IN RAISING, LOWERING, AND MOVING AUTOMOTIVE WHEELS/TIRES

(71) Applicant: Nagy Hanna, West Hills, CA (US)

(72) Inventor: Nagy Hanna, West Hills, CA (US)

(21) Appl. No.: 18/661,865

(22) Filed: May 13, 2024

(51) Int. Cl. B66F 13/00

(52) U.S. Cl. CPC B66F 13/00

(57) ABSTRACT

An attachment configured to engage with a hydraulic jack to aid in raising, lowering, and moving automotive wheels and tires may include a cradle configured to engage with the jack and hold a tire, wherein the cradle may include a pair of side plates, each having an inner face; a pair of cross supports extending between the inner faces of the pair of side plates; and a base plate attached to and extending between the pair of cross supports; and a pair of rollers adjustably engaged with and extending between the pair of side plates.

### BACKGROUND

The embodiments herein relate generally to automotive accessories, and more particularly, to an attachment for a standard hydraulic jack that aids in raising, lowering, and moving automotive wheels/tires.

When servicing automobiles with large and especially heavy wheels/tires, it is very hard to lift, move, and install/remove the wheels. Conventional devices aimed at addressing this problem are expensive standalone devices and require an attached compressed air line to function.

Therefore, what is needed is an attachment for a standard, existing hydraulic jack, wherein the attachment providing a cradle that engages with the jack and holds a tire.

### SUMMARY

Some embodiments of the present disclosure include an attachment configured to engage with a hydraulic jack to aid in raising, lowering, and moving automotive wheels and tires. The attachment may include a cradle configured to engage with the jack and hold a tire, wherein the cradle may include a pair of side plates, each having an inner face; a pair of cross supports extending between the inner faces of the pair of side plates; and a base plate attached to and extending between the pair of cross supports; and a pair of rollers adjustably engaged with and extending between the pair of side plates.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of one embodiment of the present disclosure, installed on an exemplary floor jack.

FIG. 2 is an exploded view of one embodiment of the present disclosure.

FIG. 3 is a perspective view of one embodiment of the present disclosure, shown installed on an exemplary floor jack with the floor jack raised.

FIG. 4 is a side view of one embodiment of the present disclosure.

FIG. 5 is a side view of one embodiment of the present disclosure.

FIG. 6 is a side view of one embodiment of the present disclosure, shown installed on an exemplary floor jack and engaged with an exemplary tire.

FIG. 7 is a top view of one embodiment of the present disclosure.

FIG. 8 is a top view of one embodiment of the present disclosure, showing its ability to rotate.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used as an attachment for a conventional hydraulic jack to support wheels, particularly those that are large and/or heavy, and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

The elements of the device of the present disclosure may be related in the following exemplary fashion. It is not intended to limit the scope or nature of the relationships between the various elements and the following examples are presented as illustrative examples only.

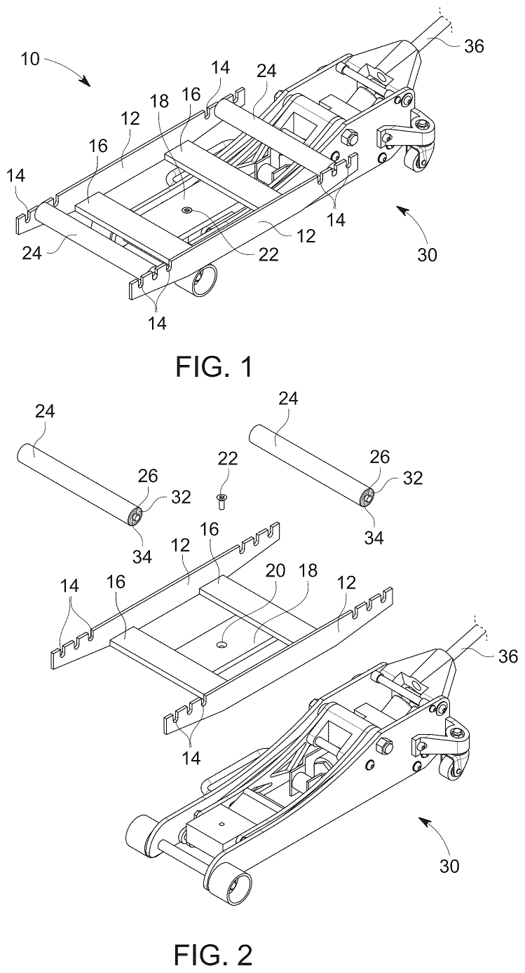

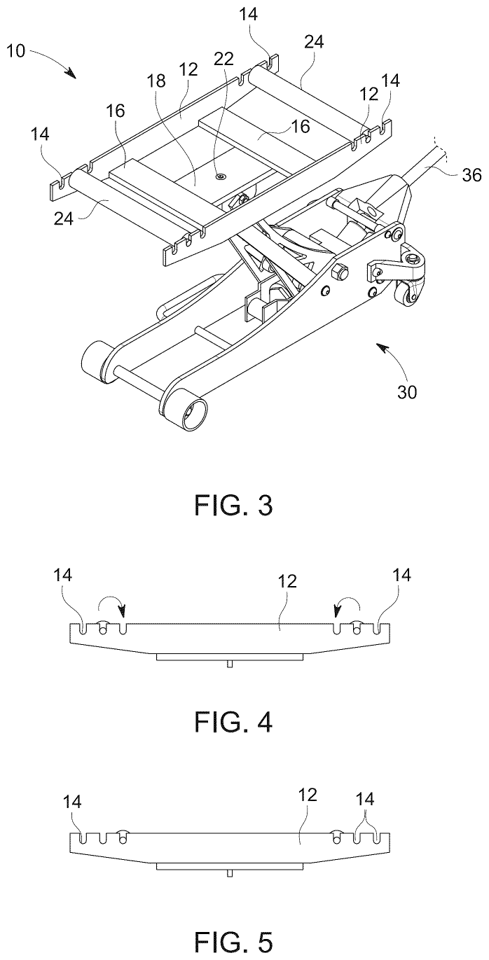

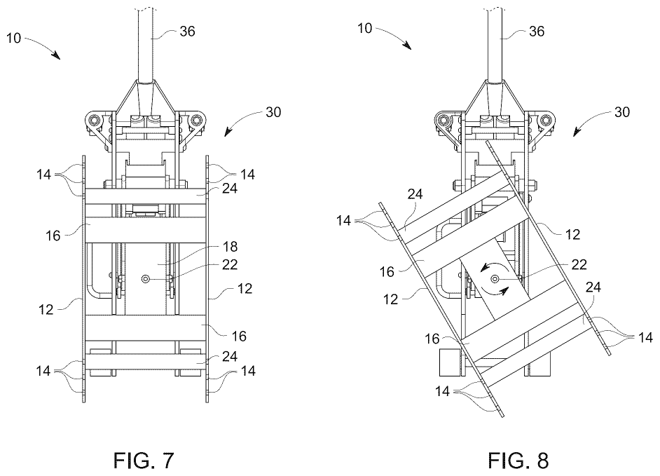

By way of example, and referring to FIGS. 1-8, some embodiments of the present disclosure include an attachment 10 configured to engage with a hydraulic jack 30, the attachment 10 designed to aid in raising, lowering, and moving automotive wheels/tires. More specifically, and as shown in the Figures, the attachment 10 may comprise a cradle configured to engage with the jack 30 and hold a tire 40, the cradle comprising a pair of side plates 12 oriented substantially parallel to one another, a pair of cross supports 16 extending between inner faces of the side plates 12, a base plate 18 attached to and extending between the cross supports 16, wherein the base plate 18 is configured to engage with the jack 30, and a pair of rollers 24 adjustably engaged with and extending between the side plates 12.

More specifically, each side plate 12 of the pair of side plates 12 may comprise an elongate planar plate with a top edge, a bottom edge, an inner face, and an outer face. The top edge of each of the side plates 12 may comprise a plurality of notches 14 extending therein. In embodiments, a first set of notches 14 may be positioned proximate to a first end of the side plate 12 and a second set of notches 14 may be positioned proximate to a second end of the side plate 12. In a particular embodiment, each set of notches 14 may comprise, for example, between 2 and 5, such as 3 notches 14. In any case, the notches 14 on the first side plate 12 may be aligned with the notches 14 on the second side plate 12. As shown in the Figures, and as described above, the side plate 12 may be substantially parallel to one another, wherein a space between the side plates 12 may be sufficient for placement of a tire 40 therebetween.

As described above and as shown in the Figures, a pair of cross supports 16 may extend between the inner face of the first side plate 12 and the inner face of the second side plate 12. The cross supports 16 may be substantially planar and parallel to one another. In some embodiments, the cross supports 16 may be substantially rectangular shaped. As shown in the Figures, the cross supports 16 may be attached to the inner face of each side plate 12 proximate to a bottom edge thereof. As such, the side plates 12 may extend vertically upwards past a top surface of the cross supports 16.

As mentioned previously, a base plate 18 may be attached to and extend between the cross supports 16. More specifically, the base plate 18 may be centered in the space between the side plates 12, wherein the base plate 18 may not attach to or abut the interior faces of the side plates 12. As shown in the Figures, the base plate 18 may be substantially planar and rectangular in shape. The base plate 18 may include an attachment mechanism for engaging with the jack 30. For example, in some embodiments, the base plate 18 may have a fastener orifice 20 extending therethrough. The fastener orifice 20 may be concentrically aligned with the base plate 18 and may be sized to accommodate insertion of a fastener, such as a bolt 22 therein, wherein the bolt 22 may be used to attach the cradle to the jack 30.

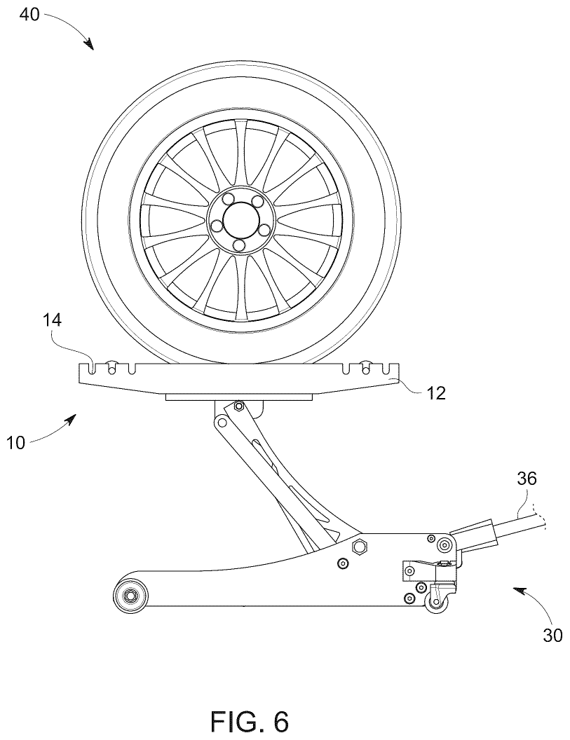

In embodiments, the attachment 10 may further comprise a pair of rollers 24 adjustably engaged with and extending between the side plates 12. The rollers 24 may each comprise a substantially rod-shaped member, wherein each end of the rod-shaped member has a roller end post 26 extending therefrom. The roller end posts 26 may be sized to fit within the notches 14 in the side plates 12. More specifically, the rollers 24, when engaged with the notches 14, may be allowed to freely rotate within the notches 14. In some embodiments, a bearing pad 32 with a bearing pad bolt hole 34 may be threaded onto the roller end posts 26 to act as a buffer between the end of the rod-shaped member and the interior face of the side plate 12. Because the rollers 24 are each adjustably engaged with the side plates 12, the distance between the rollers 24 may vary. This may allow for using the attachment 10 of the present disclosure with variously sized tires 40. Adjusting the distance between the rollers 24 may be as simple as moving the roller 24 from one notch to another, as shown in FIGS. 4 and 5.

The attachment 10 of the present disclosure may be made of any suitable or desired materials, such as steel, aluminum, or another rigid metal. The components may be welded or otherwise connected to one another. The dimensions of the attachment 10 of the present disclosure may vary. While specific shapes are mentioned above, such as the cross supports 16 and the base plate 18 being rectangular, the use of other shapes is envisioned.

To use the attachment 10 of the present disclosure, a standard saddle from a conventional hydraulic jack 30 may be removed. The attachment 10 may be attached to the saddle threads on the jack 30 using the bolt 22. The rollers 24 may then be inserted into the desired notches 14, wherein the placement of the rollers 24 may be dependent on the dimensions of the tire 40. Optional stabilizing arms may attach to the cradle to provide additional support. The jack 30 may then be used as normal, providing for lifting and maneuvering of the jack 30 using jack handle 36, wherein the attachment 10 allows the user to easily lift, move, install, and remove any sized wheel 40 more easily than conventional devices. As shown in FIG. 8, the attachment 10 may also be configured to rotate or pivot about the bolt 22 with respect to the jack 30, providing for easier positioning of the tire 40.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. An attachment configured to engage with a hydraulic jack to aid in raising, lowering, and moving automotive wheels and tires, the attachment comprising
a cradle configured to engage with the jack and hold a tire, the cradle comprising:
a pair of side plates, each having an inner face;
a pair of cross supports extending between the inner faces of the pair of side plates; and
a base plate attached to and extending between the pair of cross supports; and
a pair of rollers adjustably engaged with and extending between the pair of side plates.

2. The attachment of claim 1, wherein:
the pair of side plates are substantially parallel to one another; and
a space between the pair of side plates is sufficient for accommodating an automotive tire therein.

3. The attachment of claim 1, wherein the base plate has a fastener orifice extending therethrough, the fastener orifice sized to accommodate insertion of a fastener therethrough.

4. The attachment of claim 1, wherein:
each side plate of the pair of side plates has a top edge and a bottom edge;
the top edge of each side plate includes a plurality of notches extending therein; and
the pair of rollers are configured to be interchangeably and rotatably supported within a desired notch of the plurality of notches on each side plate.

5. The attachment of claim 4, wherein:
the plurality of notches on a first side plate of the pair of side plates comprises two sets of notches, each set being positioned proximate to a respective end of the first side plate;
the plurality of notches on a second side plate of the pair of side plates comprises two sets of notches, each set being positioned proximate to a respective end of the second side plate; and
the plurality of notches on the first side plate are aligned with the plurality of notches on the second side plate.

6. The attachment of claim 1, wherein the pair of rollers each comprise a rod-shaped member.

7. The attachment of claim 6, wherein:
each side plate of the pair of side plates has a top edge and a bottom edge;
the top edge of each side plate includes a plurality of notches extending therein;
each end of the rod-shaped member has a roller end post extending therefrom; and
the roller end posts are sized to fit within the plurality of notches in the pair side plates.

8. The attachment of claim 7, further comprising a bearing pad with a bearing pad bolt hole threaded onto the roller end posts, wherein the bearing pad is configured to act as a buffer between the end of the rod-shaped member and the interior face of the side plate.
